(19) United States
(12) Patent Application Publication
(10) Pub. No.: US 2026/0149645 A1
(43) Pub. Date: May 28, 2026

(54) DIGITAL TWIN METHOD FOR WIRELESS LOCAL AREA NETWORK, OPERATING SYSTEM, AND NON-TRANSITORY COMPUTER READABLE STORAGE MEDIUM

(71) Applicant: Wistron NeWeb Corporation, Hsinchu (TW)

(72) Inventor: Jiunn-Tsair CHEN, Hsinchu (TW)

(21) Appl. No.: 19/204,739

(22) Filed: May 12, 2025

(30) Foreign Application Priority Data
Nov. 26, 2024 (TW) 113145578

(51) Int. Cl. H04L 41/16; H04W 28/24; H04W 84/12

(52) U.S. Cl. CPC H04L 41/16; H04W 28/24; H04W 84/12

(57) ABSTRACT

A digital twin method for a wireless local area network is performed by an operating device. The digital twin method includes: obtaining a plurality of device configurations respectively corresponding to a plurality of wireless communication devices in a field; inputting the device configurations to a generative artificial intelligence (AI) model to learn a plurality of hidden variables of the generative AI model; training the generative AI model by utilizing the device configurations to generate a time structure of a realistic wireless local area network in the field; and constructing a digital twin wireless local area network corresponding to the realistic wireless local area network based on the generative AI model and the time structure.

### RELATED APPLICATIONS

This application claims the benefit of priority to Taiwan Patent Application No. 113145578, filed on Nov. 26, 2024. The entire content of the above identified application is incorporated herein by reference.

### BACKGROUND

### Technical Field

The present disclosure relates to wireless local area networks, and in particular to a digital twin method for a wireless local area network, an operating device, and a non-transitory computer readable storage medium.

### Description of Related Art

With the development of wireless communication technology and the popularization of wireless communication products, many public and private areas are now equipped with wireless local area networks to facilitate wireless communication devices in accessing the Internet. However, the configuration of a wireless local area network depends on the surrounding environment, such as the number of wireless communication devices and the layout of the field, and is also related to the adopted technical specifications and the required traffic characteristic. In other words, the configuration of the wireless local area network must be considered differently depending on various scenarios and usage requirements.

### SUMMARY

The purpose of the present disclosure is to establish a digital twin wireless local area network capable of simulating a realistic wireless local area network, which can be used to estimate the configuration states of each wireless communication device in the network and further compute the optimal configuration of the wireless local area network, thereby facilitating pre-optimization of the wireless local area network.

One aspect of the present disclosure is to provide a digital twin method for a wireless local area network. The digital twin method is performed by an operating device and includes: obtaining a plurality of device configurations respectively corresponding to a plurality of wireless communication devices in a field; inputting the device configurations into a generative artificial intelligence (AI) model to learn a plurality of hidden variables of the generative AI model; training the generative AI model using the device configurations to generate a time structure of a realistic wireless local area network in the field; and constructing a digital twin wireless local area network corresponding to the realistic wireless local area network based on the generative AI model and the time structure.

In some embodiments, each of the device configurations includes a media access control (MAC) address, an adopted local area network standard, a power characteristic, and a traffic characteristic.

In some embodiments, the power characteristic includes a power parameter for accessing a wireless access point in the field within a frequency band.

In some embodiments, the traffic characteristic includes a weekly usage day parameter, a daily usage interval parameter, and a quality of service (QoS) requirement parameter.

In some embodiments, each of the device configurations further includes a device type.

In some embodiments, the digital twin method further includes obtaining a layout of the field, in which the hidden variables are trained by inputting the device configurations and the layout into the generative AI model.

In some embodiments, the digital twin method further includes: performing a computation on the device configurations and the layout of the field using a semi-supervised clustering algorithm to generate a spatial structure of the realistic wireless local area network; and constructing a digital twin wireless local area network based on the generative AI model, the time structure, and the spatial structure.

In some embodiments, the digital twin method further includes: performing a computation on the device configurations using an unsupervised clustering algorithm to generate a spatial structure of the realistic wireless local area network; and constructing a digital twin wireless local area network based on the generative AI model, the time structure, and the spatial structure.

Another aspect of the present disclosure is to provide an operating device, which includes a communication module and a processor. The communication module is configured to communicate with at least one wireless access point in the field. The processor is coupled to the communication module and configured to perform the following operations: obtaining a plurality of device configurations respectively corresponding to a plurality of wireless communication devices in the field via the communication module; inputting the device configurations into a generative artificial intelligence (AI) model to learn a plurality of hidden variables of the generative AI model; training the generative AI model using the device configurations to generate a time structure of a realistic wireless local area network in the field; and constructing a digital twin wireless local area network corresponding to the realistic wireless local area network based on the generative AI model and the time structure.

Yet another aspect of the present disclosure is to provide a non-transitory computer readable storage medium storing a plurality of computer program instructions. When the computer program instructions are executed by a processor, the processor is caused to perform the following operations: obtaining a plurality of device configurations respectively corresponding to a plurality of wireless communication devices in a field; inputting the device configurations into a generative artificial intelligence (AI) model to learn a plurality of hidden variables of the generative AI model; training the generative AI model using the device configurations to generate a time structure of a realistic wireless local area network in the field; and constructing a digital twin wireless local area network corresponding to the realistic wireless local area network based on the generative AI model and the time structure.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a wireless local area network and an operating device according to an embodiment of the present disclosure.

FIGS. 2A and 2B respectively illustrate an example of a wireless local area network configured in different floor layouts of a field.

FIG. 3 is a flow diagram of a digital twin method for a wireless local area network according to an embodiment of the present disclosure.

FIGS. 4A and 4B respectively show correlation coefficients of traffic throughput by hour and by day in the field.

FIG. 5 is a radio frequency signal power intensity distribution diagram of a wireless access point in a specific field according to one example.

FIGS. 6A and 6B respectively show the Davies-Bouldin index and signal spatial occupancy for a field as shown in FIG. 5 with four wireless access points and uniformly distributed wireless communication devices.

FIGS. 7A and 7B respectively show the Davies-Bouldin index and signal spatial occupancy for a field as shown in FIG. 5 with four wireless access points and non-uniformly distributed wireless communication devices.

FIG. 8 is a block diagram of an operating device according to an embodiment of the present disclosure.

### DETAILED DESCRIPTION

The present disclosure is more particularly described in the following embodiments that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second,” and “third” can be used to describe various components, signals or the like, which are for distinguishing one component/signal from another one only, and are not intended to, nor should be construed to impose any substantive limitations on the components, signals or the like.

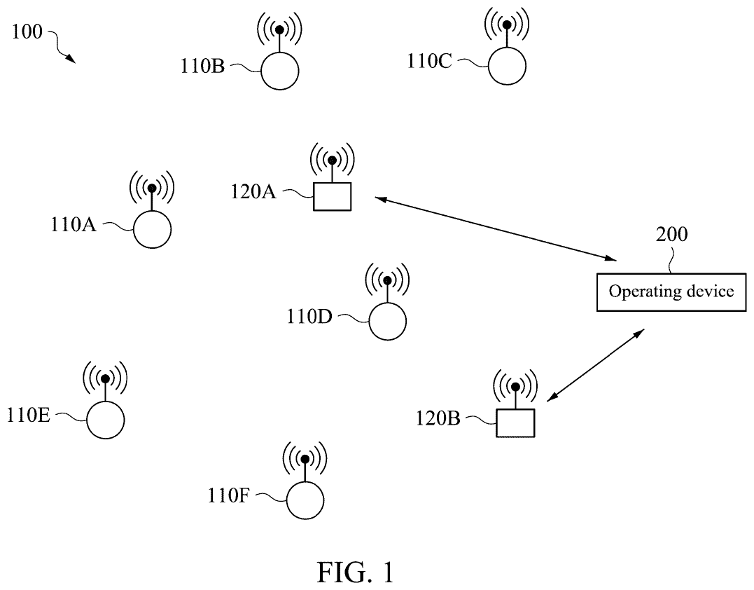

FIG. 1 is a schematic diagram of a wireless local area network 100 and an operating device 200 according to an embodiment of the present disclosure. As shown in FIG. 1, the wireless local area network 100 includes wireless communication devices 110A-110F and wireless access points 120A and 120B. The wireless communication devices 110A-110F are capable of transmitting and receiving wireless signals, and the wireless access points 120A and 120B provide wireless access services within a certain range, allowing the wireless communication devices 110A-110F to wirelessly connect to the wireless access points 120A and 120B via wireless channels in order to access a local network and/or an external network (e.g., the Internet). The wireless local area network 100 may be a Wi-Fi mesh network, in which the wireless access points 120A and 120B may have the same or different service set identifiers (SSIDs). When both access points 120A and 120B use the same SSID, the wireless communication devices 110A-110F can seamlessly switch between wireless connections to the access points 120A and 120B. It should be noted that the number of wireless communication devices and access points shown in FIG. 1 is for illustrative purposes only and does not impose any limitation on the present disclosure.

The operating device 200 is communicatively connected to the wireless access points 120A and 120B within the wireless local area network 100. The operating device 200 may be, for example, a desktop computer, a laptop, a tablet, a smartphone, a workstation, or another electronic device with computing and communication capabilities. In other embodiments, the operating device 200 may be directly connected to one of the wireless access points (e.g., wireless access point 120A) and may transmit data to another access point (e.g., access point 120B) via that connection. The operating device 200 may belong to the same wireless local area network 100 as the wireless communication devices 110A-110F and the wireless access points 120A and 120B, or it may be a remote device relative to the wireless local area network 100.

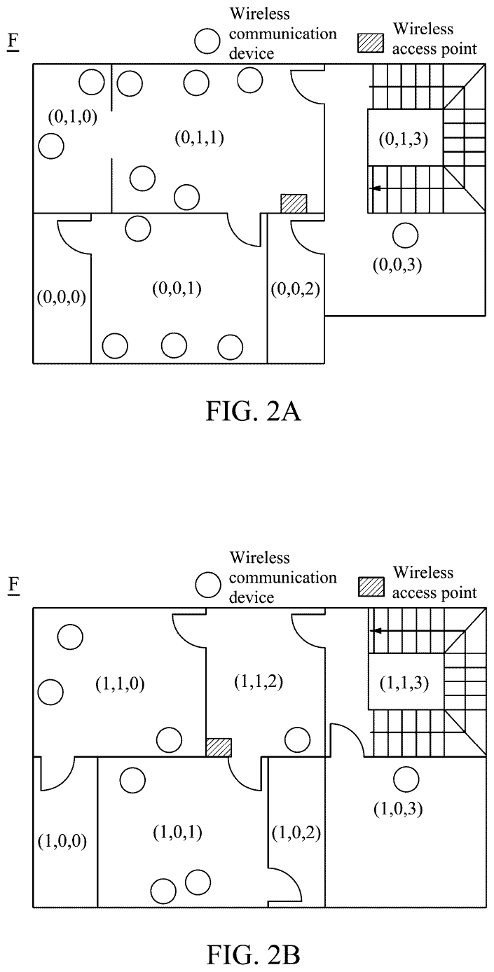

FIGS. 2A and 2B respectively illustrate an example in which a wireless local area network is deployed across different floor layouts of a field F. As shown in FIGS. 2A and 2B, the field F is a townhouse or a detached house, with each floor having multiple partitions separated by walls, and some of the partitions contain wireless communication devices and/or wireless access points. In other examples, the field F may be an office, a factory, a hospital, a school, a shopping mall, or the like, but is not limited thereto. Likewise, the layout of field F, the number of wireless communication devices and wireless access points, and their respective positions in field F as illustrated in FIGS. 2A and 2B are provided merely as examples and do not limit the scope of the present disclosure.

However, in the examples of FIGS. 2A and 2B, since some wireless communication devices may be portable or mobile, the configuration of the wireless local area network needs to be adjusted in real-time according to the actual usage conditions, in order to provide optimal performance at different times.

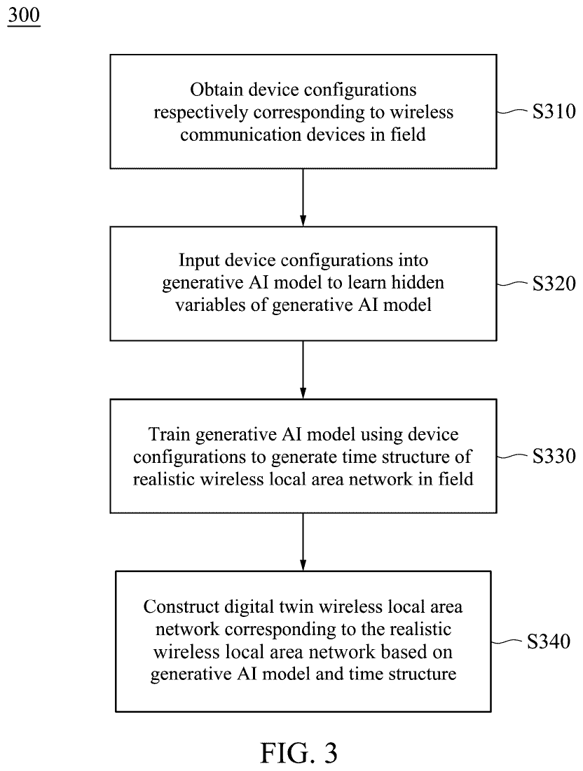

FIG. 3 is a flow diagram illustrating a digital twin method 300 for a wireless local area network according to an embodiment of the present disclosure. The digital twin method 300 is used to establish a digital twin wireless local area network and may be performed by other electronic devices with computing and communication capabilities. Referring to the schematic in FIG. 1 as an example, the digital twin method 300 is used to construct a digital twin wireless local area network corresponding to the wireless local area network 100, and may be performed by the operating device 200.

The digital twin method 300 is described as follows. First, in operation S310, a plurality of device configurations respectively corresponding to a plurality of wireless communication devices in a field are obtained. The device configurations may be acquired through wireless access points connected to the wireless communication devices within the wireless local area network. Each device configuration may include a media access control (MAC) address, an adopted wireless local area network standard, a power characteristic, a traffic characteristic, and/or another configuration parameter. The MAC address is used to identify the wireless communication device. The adopted wireless local area network standard may be, for example, IEEE 802.11a/b/g/n/ac/ax/be or a more advanced standard. The power characteristic may include power parameters for accessing wireless access points in the field within specific frequency bands, such as received power levels at 2.4 GHz, 5 GHz, and/or 6 GHz bands, which is associated with the strength of the received signal. The traffic characteristic may include a weekly usage day parameter, a daily usage interval parameter, and a quality of service (QoS) requirement parameter. The weekly usage day parameter represents the distribution of usage days in a week, the daily usage interval parameter represents the time-of-day distribution, and the QoS requirement parameter represents the requirements for throughput, jitter, delay, and packet loss for traffics. The QoS requirement parameter applied to wireless local area networks may be categorized into voice, video, best effort, and background. For example, if a wireless communication device is used in the field to watch streaming video every Monday to Friday from 8 PM to 10 PM, then its traffic characteristic include: weekly usage day parameter representing Monday to Friday, daily usage interval parameter representing 8 PM to 10 PM, and QoS requirement parameter representing video. It should be noted that each wireless communication device may have multiple traffic characteristics.

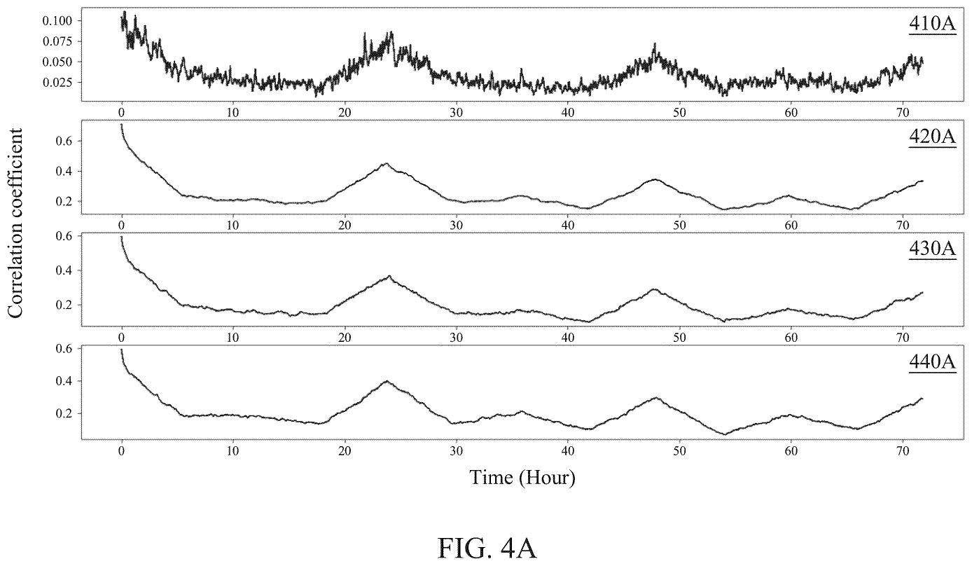

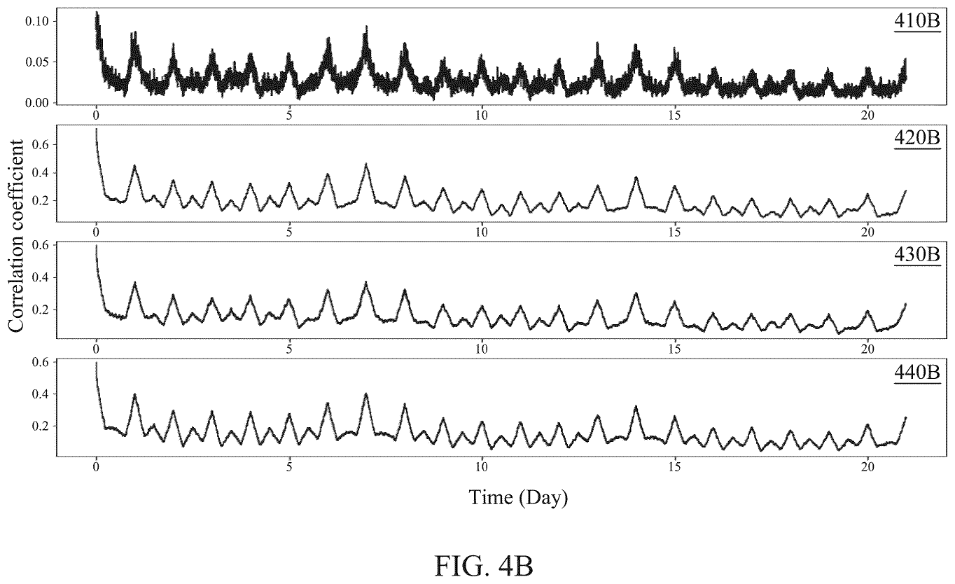

For example, FIGS. 4A and 4B respectively illustrate the correlation coefficient of traffic throughput in field F by hour and by day. In FIG. 4A, lines 410A, 420A, 430A, and 440A respectively represent the correlation coefficients of traffic throughput for the QoS requirement parameters: voice, video, best effort, and background. As shown in FIG. 4A, for all four QoS requirement parameters, the correlation coefficient of traffic throughput reaches a peak every 24 hours. The correlation coefficient at hour 48 is lower than that at hour 24, and the coefficient at hour 72 is lower than that at hour 48. In FIG. 4B, lines 410B, 420B, 430B, and 440B similarly represent the correlation coefficients of traffic throughput for the same QoS requirement parameters. As indicated by FIG. 4B, the correlation coefficient of traffic throughput peaks every 7 days (i.e., on day 7, day 14, and day 21), with the coefficient at day 14 being lower than that at day 7, and the coefficient at day 21 being lower than that at day 14.From FIGS. 4A and 4B, it is evident that the traffic characteristics of different QoS requirements within the same field F exhibit significant temporal structural properties. Additionally, based on the traffic usage characteristics, the variation in the correlation coefficient for voice QoS traffic throughput is greater than those of the other three QoS types.

Each device configuration may also include a device type, which can be categorized into fixed devices (e.g., smart TVs), portable devices (e.g., laptops), and mobile devices (e.g., mobile phones). Each device configuration may further include events such as entering or leaving the field and the movement trajectories while accessing the network within the field.

In addition, in some special scenarios, such as when multiple people are gathering in the field for a party, the wireless communication devices in the field may include temporary wireless communication devices. Specifically, in these special scenarios, operation S310 may further include pre-registering multiple temporary wireless communication devices expected to appear in the field, and providing a corresponding device configuration for each of these temporary wireless communication devices. The description of each temporary wireless communication device's configuration is provided in previous paragraphs and will not be repeated here.

Next, in operation S320, the device configurations are input into a generative artificial intelligence (AI) model to learn a plurality of hidden variables of the generative AI model. The generative AI model used may be, for example, a generative Gaussian mixture network, a generative adversarial network (GAN), an artificial neural network (ANN), or another suitable model. Algorithms such as, but not limited to, a Kalman filter algorithm, an autoregressive integrated moving average model (ARIMA), or a particle filter algorithm may be used to estimate the configuration status of each wireless communication device at the next time point and the related hidden variables. These hidden variables may include the location of each wireless access point in the field, the layout of the field (including floors, spaces, and wall arrangements), and signal attenuation factors (such as signal strength attenuation caused by walls made of different materials).

In an alternative embodiment, the layout of the field is known (i.e., previously acquired), and the hidden variables are trained by inputting the device configurations and the layout into the generative AI model.

Furthermore, based on the configuration states of each wireless communication device over a series of consecutive time points, a discriminative machine learning model may be used to compute the optimal configuration of the wireless communication network. This includes backend optimization settings, channel selection for each wireless communication device, band steering, and QoS settings corresponding to different types of traffic. Alternatively, the optimal configuration of the wireless communication network may be computed based on specific rules (such as power, frequency band, rate, QoS, and/or other constraints). Since the estimated configuration states may change over time, the computed optimal configuration of the wireless communication network may also vary accordingly.

Then, in operation S330, the generative AI model is trained using the device configurations to generate the time structure of the realistic wireless local area network in the field. When a sufficient amount of historical data of device configurations has been accumulated, the resulting time structure can accurately indicate, with high probability, what type and QoS level of traffic is needed by the wireless devices in the field at a given day and time, and whether their location status is fixed or mobile.

Next, in operation S340, a digital twin wireless local area network corresponding to the realistic wireless local area network is constructed based on the generative AI model and the time structure. With sufficient training of the generative AI model, the constructed digital twin wireless local area network can more accurately simulate the real network, thereby facilitating subsequent network analysis or predictive/preventive network optimization operations.

In some embodiments, the digital twin wireless local area network may be constructed based on the generative AI model, the time structure, and the spatial structure. Under the condition that the layout of the field and the three-dimensional grid index values of each wireless access point in the field are known, a semi-supervised clustering algorithm may be used to compute the device configurations and the field layout in the field to generate the spatial structure of the realistic wireless local area network. The known layout of the field may be a rough layout, for example, including the position of each partition in the field and its three-dimensional grid index value. Taking FIGS. 2A and 2B as examples, in the floor layout shown in FIG. 2A, the grid index values of the lower-row partitions from left to right may be (0,0,0), (0,0,1), (0,0,2), and (0,0,3), and the upper-row partitions from left to right may be (0,1,0), (0,1,1), and (0,1,3). In the floor layout shown in FIG. 2B, the lower-row partitions from left to right may be (1,0,0), (1,0,1), (1,0,2), and (1,0,3), and the upper-row partitions from left to right may be (1,1,0), (1,1,2), and (1,1,3). Specifically, the power characteristics of the device configurations can be used as input parameters, and the field layout, the three-dimensional grid index values of each wireless access point in the field, and signal attenuation levels of obstacles such as walls can be used as prior knowledge. A semi-supervised clustering algorithm is then applied to compute the three-dimensional grid index values of all wireless communication devices. The obtained grid index values of wireless communication devices can be used to learn the prior power characteristics of any wireless communication devices with the same grid index values, which helps observe the signal attenuation effects of obstacles without the need for time-consuming pretraining of power characteristics.

When the layout of the field is unknown, an unsupervised clustering algorithm may be used to compute the device configurations to generate the spatial structure of the realistic wireless local area network. The digital twin wireless local area network is then constructed based on the generative AI model, the time structure, and the spatial structure. The spatial structure generated in this manner may, for example, be a clustering of wireless communication devices and wireless access points according to the partitions in the field.

The aforementioned semi-supervised clustering algorithms and unsupervised clustering algorithms may include, but are not limited to, the K-means algorithm, support vector machine (SVM) algorithms with Gaussian kernels, and/or random forest algorithms.

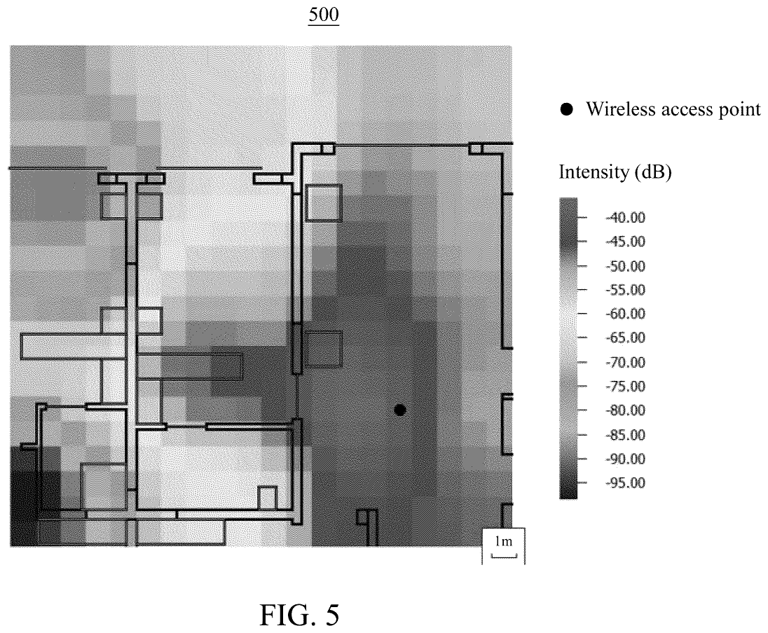

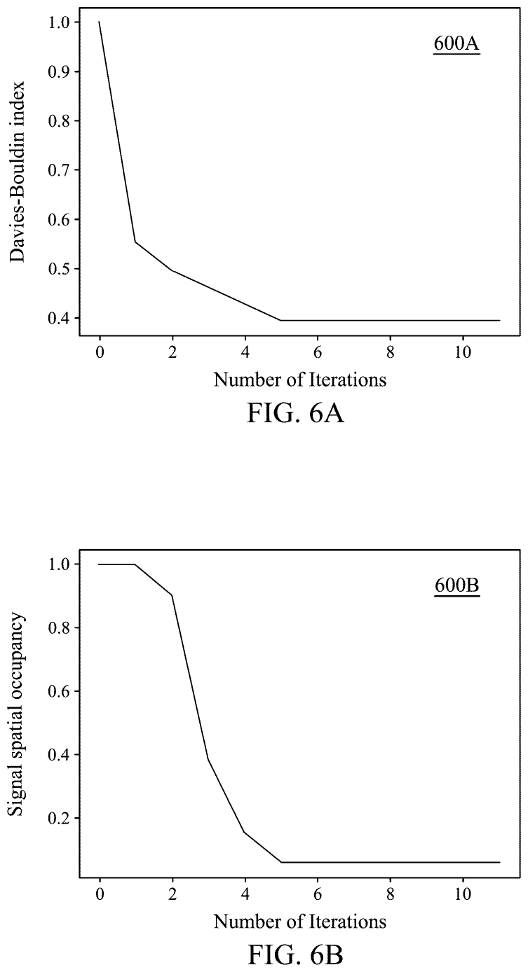

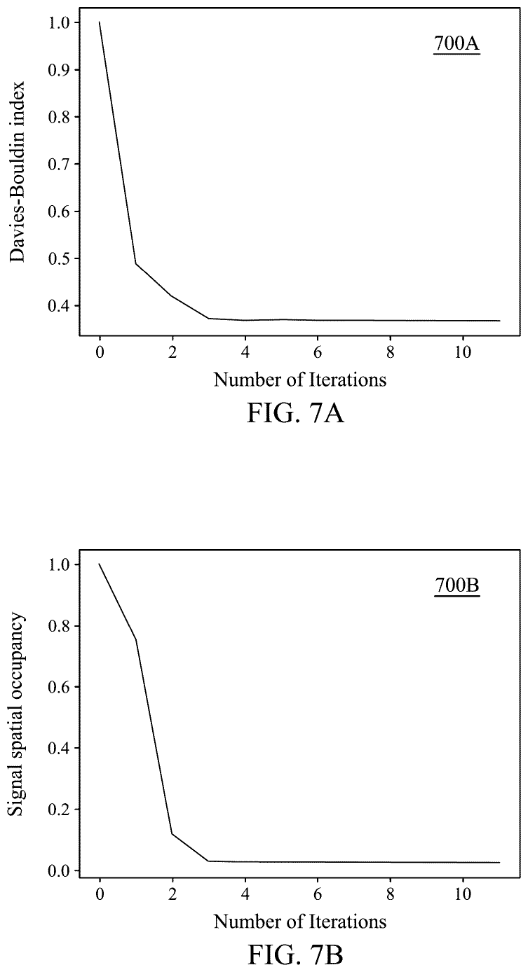

The following provides an example using the K-means algorithm. FIG. 5 shows a radio frequency signal power intensity distribution diagram 500 of a wireless access point in a specific field according to one example. As illustrated in FIG. 5, the RF signal power intensity is highest at and near the location of the wireless access point, and it decreases with increasing distance from the access point, showing significant attenuation after passing through obstacles such as walls, large appliances, and furniture. FIGS. 6A and 6B respectively show the Davies-Bouldin index and signal spatial occupancy in the specific field illustrated in FIG. 5 under conditions where there are four wireless access points and uniformly distributed wireless communication devices. As shown in FIGS. 6A and 6B, after five iterations, the Davies-Bouldin index (line 600A) and the signal spatial occupancy (line 600B) converge to approximately 0.395 and 0.0587, respectively. Furthermore, FIGS. 7A and 7B show the Davies-Bouldin index and signal spatial occupancy under the same field conditions but with non-uniformly distributed wireless communication devices. As illustrated in FIGS. 7A and 7B, after five iterations, the Davies-Bouldin index (line 700A) and the signal spatial occupancy (line 700B) converge to approximately 0.368 and 0.0259, respectively. These results indicate that even with uniformly distributed wireless communication devices in a specific field, the Davies-Bouldin index remains at about 0.395, indicating good spatial clustering quality, and that signals appear in only approximately 5.87% of the space. Under non-uniform distribution, the Davies-Bouldin index further decreases to approximately 0.368, and the signal is constrained to only about 2.59% of the space. Therefore, regardless of the distribution pattern of wireless communication devices, a significant spatial structure characteristic can still be derived.

The digital twin method 300 may be programmed as computer program instructions, which can be executed by a processor and stored on a non-transitory computer readable medium accessible by the processor. When the computer program instructions are executed by the processor, the processor performs the various operations in the digital twin method 300. The non-transitory computer readable medium may include a read-only memory (ROM), flash memory, floppy disk, hard disk, solid-state disk (SSD), optical disk, universal serial bus (USB) flash drive, magnetic tape, an Internet-accessible database, or any other computer readable medium apparent to those of ordinary skill in the relevant technical field.

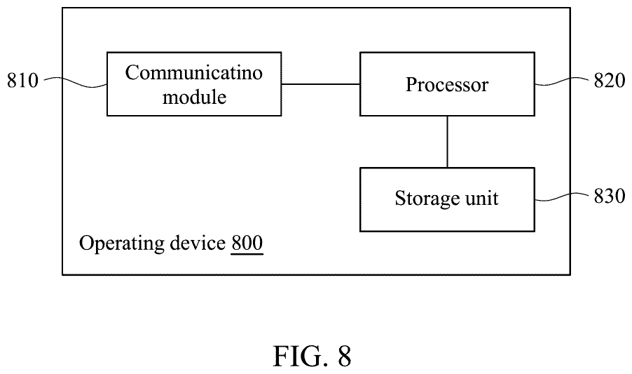

FIG. 8 is a block diagram of an operating device 800 according to an embodiment of the present disclosure. The operating device 800 may be, for example, the operating device 200 or another electronic device with computing capabilities. As shown in FIG. 8, the operating device 800 includes a communication module 810, a processor 820, and a storage unit 830.

The communication module 810 is configured to communicate with wireless access points in the field. Depending on the communication method between the operating device 800 and the wireless access point, the communication module 810 may be a wired communication interface, such as a universal serial bus (USB) interface or an RJ45 interface, or a wireless communication interface, such as a wireless local area network communication module or a Bluetooth communication module.

The processor 820 is coupled to the communication module 810 and is configured to obtain, via the communication module 810, a plurality of device configurations respectively corresponding to multiple wireless communication devices communicatively connected to the wireless access point in the field. The processor then inputs the device configurations into a generative AI model to learn a plurality of hidden variables of the generative AI model, and subsequently trains the model using the device configurations to generate a time structure of the realistic wireless local area network in the field. Based on the generative AI model and the time structure, the processor constructs a digital twin wireless local area network corresponding to the realistic one. The processor 820 may be a central processing unit (CPU), a graphics processing unit (GPU), a microcontroller unit (MCU), a microprocessor, system-on-chip (SoC), a digital signal processor (DSP), an application-specific integrated circuit (ASIC), a programmable logic controller (PLC), or another circuit with computing capability. Detailed operations for establishing the digital twin wireless local area network by the processor 820 are described in the digital twin method 300 and will not be repeated here.

The storage unit 830 is coupled to the processor 820 and may be any type of data storage device accessible by the processor 820 for performing operations related to the construction of the digital twin wireless local area network. The storage unit 830 may be, for example, a read-only memory (ROM), an erasable programmable read-only memory (EPROM), an electrically erasable programmable read-only memory (EEPROM), a compact disc read-only memory (CD-ROM), a magnetic tape, a hard disk, a solid-state disk (SSD), a flash memory, or other non-transitory computer readable storage media suitable for storing program code.

In summary, the digital twin wireless local area network established according to the embodiments of the present disclosure can simulate a realistic wireless local area network. It can be used to estimate the configuration states of each wireless communication device within the wireless local area network and further compute the optimal configuration of the wireless local area network, thereby facilitating pre-optimization of the wireless local area network.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A digital twin method for a wireless local area network performed by an operating device, the digital twin method comprising:
obtaining a plurality of device configurations respectively corresponding to a plurality of wireless communication devices in a field;
inputting the plurality of device configurations into a generative artificial intelligence (AI) model to learn a plurality of hidden variables of the generative AI model;
training the generative AI model using the plurality of device configurations to generate a time structure of a realistic wireless local area network in the field; and
constructing a digital twin wireless local area network corresponding to the realistic wireless local area network based on the generative AI model and the time structure.

2. The digital twin method of claim 1, wherein each of the plurality of device configurations comprises a media access control (MAC) address, an adopted wireless local area network standard, a power characteristic, and a traffic characteristic.

3. The digital twin method of claim 2, wherein the power characteristic comprises a power parameter for accessing a wireless access point in the field within a frequency band.

4. The digital twin method of claim 2, wherein the traffic characteristic comprises a weekly usage day parameter, a daily usage interval parameter, and a quality of service (QoS) requirement parameter.

5. The digital twin method of claim 1, wherein each of the plurality of device configurations further comprises a device type.

6. The digital twin method of claim 1, further comprising:
obtaining a layout of the field;
wherein the plurality of hidden variables are trained by inputting the plurality of device configurations and the layout into the generative AI model.

7. The digital twin method of claim 1, further comprising:
performing a computation on the plurality of device configurations and a layout of the field using a semi-supervised clustering algorithm to generate a spatial structure of the realistic wireless local area network; and
constructing the digital twin wireless local area network based on the generative AI model, the time structure, and the spatial structure.

8. The digital twin method of claim 1, further comprising:
performing a computation on the plurality of device configurations using an unsupervised clustering algorithm to generate a spatial structure of the realistic wireless local area network; and
constructing the digital twin wireless local area network based on the generative AI model, the time structure, and the spatial structure.

9. An operating device, comprising:
a communication module configured to communicate with at least one wireless access point in a field;
a processor coupled to the communication module, the processor configured to:
obtain, via the communication module, a plurality of device configurations respectively corresponding to a plurality of wireless communication devices communicatively connected to the at least one wireless access point in the field;
input the plurality of device configurations into a generative artificial intelligence (AI) model to learn a plurality of hidden variables of the generative AI model;
train the generative AI model using the plurality of device configurations to generate a time structure of a realistic wireless local area network in the field; and
construct a digital twin wireless local area network corresponding to the realistic wireless local area network based on the generative AI model and the time structure.

10. A non-transitory computer readable storage medium storing a plurality of computer program instructions, which, when executed by a processor, cause the processor to perform the following operations:
obtaining a plurality of device configurations respectively corresponding to a plurality of wireless communication devices in a field;
inputting the plurality of device configurations into a generative artificial intelligence (AI) model to learn a plurality of hidden variables of the generative AI model;
training the generative AI model using the plurality of device configurations to generate a time structure of a realistic wireless local area network in the field; and
constructing a digital twin wireless local area network corresponding to the realistic wireless local area network based on the generative AI model and the time structure.
